(19) United States
(12) Patent Application Publication
(10) Pub. No.: US 2023/0232210 A1
(43) Pub. Date: Jul. 20, 2023

(54) TRANSPOSITIONAL MODULATION FORTIFIED COMMUNICATIONS

(71) Applicant: TM IP HOLDINGS, LLC, Tucson, AZ (US)

(72) Inventors: Scott VELAZQUEZ, Tucson, AZ (US); Mohan TAMMISETTI, Tucson, AZ (US)

(21) Appl. No.: 17/751,470

(22) Filed: May 23, 2022

Related U.S. Application Data
(63) Continuation-in-part of application No. 16/436,381, filed on Jun. 10, 2019, now Pat. No. 11,343,670.
Application No. 16/436,381 is a continuation of application No. 15/880,753, filed on Jan. 26, 2018, now Pat. No. 10,321,304.
Application No. 15/880,753 is a continuation of application No. 15/655,380, filed on Jul. 20, 2017, now Pat. No. 9,883,375.
Application No. 15/655,380 is a continuation of application No. 15/367,482, filed on Dec. 2, 2016, now Pat. No. 9,716,997.
Application No. 15/367,482 is a continuation of application No. 15/133,589, filed on Apr. 20, 2016, now Pat. No. 9,516,490.
(60) Provisional application No. 63/323,018, filed on Mar. 23, 2022.

(51) Int. Cl. H04W 8/22; H04W 8/00; G01S 13/76; G01S 7/00

(52) U.S. Cl. CPC H04W 8/22; G01S 7/003; G01S 13/765; H04W 8/005; H04L 27/0012

(57) ABSTRACT

A method and system for transpositional modulation fortified communication includes an original carrier of an RF channel operating within a spectral mask. The original carrier has a carrier signal with a first quantity of data. At least one transpositional modulation (TM) channel has a TM signal second quantity of data. The at least one TM channel is added to the original carrier thereby generating a TM fortified carrier signal having the first and second quantities of data. The at least one TM channel and the original carrier do not exceed the spectral mask. At least one device with a receiver receives the TM fortified carrier signal.

### CROSS REFERENCE TO RELATED APPLICATION

This application is a continuation-in-part application of U.S. Pat. application Ser. No. 16/436,381 filed on Jun. 10, 2019, which is a continuation application of U.S. Pat. application Ser. No. 15/880,753, filed on Jan. 26, 2018, now U.S. Pat. No. 10,321,304, which is a continuation application of U.S. Pat. application Ser. No. 15/655,380, filed on Jul. 20, 2017, now U.S. Pat. No. 9,883,375, which is a continuation application of U.S. Pat. application Ser. No. 15/367,482, filed on Dec. 2, 2016, now U.S. Pat. No. 9,716,997, which is a continuation of U.S. Pat. application Ser. No. 15/133,589, filed on Apr. 20, 2016, now U.S. Pat. No. 9,516,490, and claims benefit to U.S. Provisional Pat. Application Ser. No. 63/323,018, filed Mar. 23, 2022, which are hereby incorporated by reference in their entirety.

### FIELD OF THE DISCLOSURE

The present disclosure is generally related to RF signal transmission and more particularly is related to transpositional modulation fortified communications.

### BACKGROUND OF THE DISCLOSURE

Radio frequency (RF) sinusoidal waveforms are transmitted from one location to another to convey data. When an RF wireless waveform is transmitted, it often goes through transformations within different aspects of the transmitter, receiver, and/or transceiver, as the case may be. For example, noise, often referred to as white Gaussian noise, is added to the transmitted signal, and when received, the receiver will receive both the original signal and the noise together. For digital communications, various components are used to transmit the original signal and receive the original signal with noise added, and then separate the noise from the original signal to obtain the underlying data of the original signal.

It is common to use modulation techniques with RF signals, where information is added to the original signal. For instance, carrier modulation techniques are used to transmit information signals from one location to another. Traditional signal modulation techniques include, for example, amplitude modulation (AM), frequency modulation (FM), phase modulation (PM). In addition, complex modulation techniques exist that incorporate aspects of AM, FM, and PM such as quadrature phase shift keying (QPSK), amplitude phase shift keying (APSK) and including quadrature amplitude modulation (QAM). While these modulation techniques exist, they fall short of meeting the current and future needs of wireless signal transmission.

Thus, a heretofore unaddressed need exists in the industry to address the aforementioned deficiencies and inadequacies.

### SUMMARY OF THE DISCLOSURE

Embodiments of the present disclosure provide a system for transpositional modulation fortified communication. Briefly described, in architecture, one embodiment of the system, among others, can be implemented as follows. An original carrier of an RF channel operates within a spectral mask, the original carrier having a carrier signal with a first quantity of data. At least one transpositional modulation (TM) channel has a TM signal second quantity of data, wherein the at least one TM channel is added to the original carrier thereby generating a TM fortified carrier signal having the first and second quantities of data, wherein the at least one TM channel and the original carrier do not exceed the spectral mask. At least one device with a receiver receives the TM fortified carrier signal.

In one aspect of the system, the at least one TM channel utilizes sidebands within the spectral mask.

In another aspect, the spectral mask is defined by at least one of the FCC, the ITU, or the ETSI.

In yet another aspect, the receiver further comprises a non-TM receiver, wherein the non-TM receiver receives the first quantity of data but ignores the second quantity of data.

In this aspect, the second quantity of data is obfuscated from the at least one device.

In another aspect, the receiver further comprises a TM receiver, wherein the TM receiver receives the first and second quantities of data.

In yet another aspect, the TM signal is demodulated to be orthogonal to a matched filter used for a waveform of carrier signal.

In another aspect, the TM fortified carrier signal further comprises multiple data paths, wherein the first and second quantities of data are transmittable along different paths of the multiple data paths.

In this aspect, the multiple data paths provide full duplex operation on a single frequency carrier.

The present disclosure can also be viewed as providing methods of transpositional modulation fortified communication. In this regard, one embodiment of such a method, among others, can be broadly summarized by the following steps: operating an original carrier of an RF channel within a spectral mask, wherein the original carrier has a carrier signal with a first quantity of data; adding at least one transpositional modulation (TM) channel having a TM signal second quantity of data to the original carrier thereby generating a TM fortified carrier signal having the first and second quantities of data, wherein the at least one TM channel and the original carrier do not exceed the spectral mask; and receiving the TM fortified carrier signal at least one device with a receiver.

In one aspect of the method, the at least one TM channel utilizes sidebands within the spectral mask.

In another aspect, the spectral mask is defined by at least one of the FCC, the ITU, or the ETSI.

In yet another aspect, the receiver further comprises a non-TM receiver, wherein the non-TM receiver receives the first quantity of data but ignores the second quantity of data, thereby obfuscating the second quantity of data from the at least one device.

In another aspect, the receiver further comprises a TM receiver, wherein the TM receiver receives the first and second quantities of data.

In yet another aspect, the TM signal is demodulated to be orthogonal to a matched filter used for a waveform of carrier signal.

In another aspect, the TM fortified carrier signal further comprises multiple data paths, wherein the first and second quantities of data are transmittable along different paths of the multiple data paths.

In yet another aspect, the multiple data paths provide full duplex operation on a single frequency carrier.

The present disclosure can also be viewed as providing a system for highly secured signal communication using transpositional modulation. Briefly described, in architecture, one embodiment of the system, among others, can be implemented as follows. An original carrier of an RF channel operates within a spectral mask, the original carrier having a carrier signal with a first quantity of data. At least one transpositional modulation (TM) channel has a TM signal second quantity of data, wherein the at least one TM channel is added to the original carrier thereby generating a TM fortified carrier signal having the first and second quantities of data, wherein the at least Xone TM channel and the original carrier do not exceed the spectral mask. An access traffic steering, switching, and splitting (ATSSS) unit directs Xthe TM fortified carrier signal through at least first and second networks, wherein at least a portion of the first quantity of data is transmitted through the first network and at least a portion of the second quantity of data is transmitted through the second network. The first and second networks have at least one of: different network speeds; different privacy protocols; or different security protocols. At least one device with a receiver receives at least one of the first and second quantities of data within the TM fortified carrier signal.

In one aspect of the system, the receiver of the at least one device further comprises a non-TM receiver, wherein the non-TM receiver receives the first quantity of data but ignores the second quantity of data, wherein the second quantity of data is obfuscated from the at least one device.

In another aspect, the receiver of the at least one device further comprises a TM receiver, wherein the TM receiver receives the first and second quantities of data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graphical illustration of spectral spreading headroom, in accordance with embodiments of the present disclosure.

FIG. 2 is a graphical illustration of the frequency response of a matched filter used to demodulate a TM signal, in accordance with embodiments of the present disclosure.

FIG. 3 is a graphical illustration of a total received spectrum of a legacy signal and TM signal of FIG. 2, in accordance with embodiments of the present disclosure.

FIG. 4 is a graphical illustration of detected and enhanced TM signals after application of the orthogonal matched filter of FIG. 2, in accordance with embodiments of the present disclosure.

FIG. 5 is a diagrammatical illustration of an adaptive multi-dimensional compensator applied to predistortion of an RF transmitter, in accordance with embodiments of the present disclosure.

FIG. 6 is a graphical illustration showing the effect of digital pre-distortion (DPD) linearization on a modulated waveform, in accordance with embodiments of the present disclosure.

FIG. 7 is a graphical illustration showing experimentation results showing the spectrum with TM signals, in accordance with embodiments of the present disclosure.

FIG. 8 is a graphical illustration constellation plot for the original legacy signal and one of the TM signals of the experimentation of FIG. 7, in accordance with embodiments of the present disclosure.

FIG. 9 is a diagrammatical illustration of a system for transpositional modulation fortified communication, in accordance with embodiments of the present disclosure.

FIG. 10 is a diagrammatical illustration of a system for transpositional modulation fortified communication with network splitting, in accordance with embodiments of the present disclosure.

FIG. 11 is a flowchart illustrating a method of transpositional modulation fortified communication, in accordance with embodiments of the present disclosure.

### DETAILED DESCRIPTION

To improve over conventional RF signal transmission and modulation techniques, the present disclosure is directed to transpositional modulation (TM) techniques which can provide benefits with wireless RF transmission in terms of spectrum efficiency, private and obfuscated communications, and other benefits. TM is a RF waveform technology that can offer significant bandwidth increases for existing wireless and wired networks. These bandwidth increases are accomplished by enabling the simultaneous transmission of two or more distinct data paths on a single carrier signal, which effectively doubles the efficiency of the carrier wave. Moreover, the benefits of TM in radio communications provide a new method of carrier signal modulation and works as a foundational waveform.

Additionally, TM can provide for overlaying one type of modulation on top of another with very low, near zero, increases in interference or noise. TM has also been proven to function well with existing compression, encryption, or coding methods. This transparency is compatible even with complex modulations such as QAM, n-phase shift keying (n-PSK), and orthogonal frequency-division multiplexing (OFDM). Because of its transparency and ultra-efficient characteristics, TM allows the transmission of two or more signals simultaneously instead of one signal, as with other modulations, all without destroying the integrity of the individual bit streams.

Efficient digital pre-distortion (DPD) linearization techniques are used to reduce intermodulation distortion in the transceiver hardware to allow the addition of transparent TM signals without exceeding regulatory mask requirements. In effect, the additional TM signals appear to be nonlinear distortion that existing receivers and waveforms are already provisioned to handle and ignore. TM can coexist simultaneously in a signal transmission with the existing modulation technologies allowing the transmission of more data for a given bandwidth. In addition, obfuscated communications are possible since the additional TM signals are indistinguishable from ordinary intermodulation distortion.

It is known that adding waveforms to an existing communications system can affect one or both of the spectral spreading or signal-to-interference-plus-noise ratio (SINR) of the system. In addition, the arbitrary summation of uncorrelated waveforms presents significant co-channel interference problems. The amount of headroom available for signal transmission under regulatory power limits and the resulting SINR of the TM composite waveform may determine how much increase in communication capacity can realistically be achieved. Increasing the headroom, such as with advanced DPD linearization techniques, can significantly increase the overall communications capacity by supporting additional transmission energy for embedded TM signals in the typically unused mask shoulders. The regional regulatory governance, such as the Federal Communications Commission (FCC), the International Telecommunication Union (ITU), or the European Telecommunications Standards Institute (ETSI), or others, specifies the frequency mask power limits and how much spectral spread is allowable.

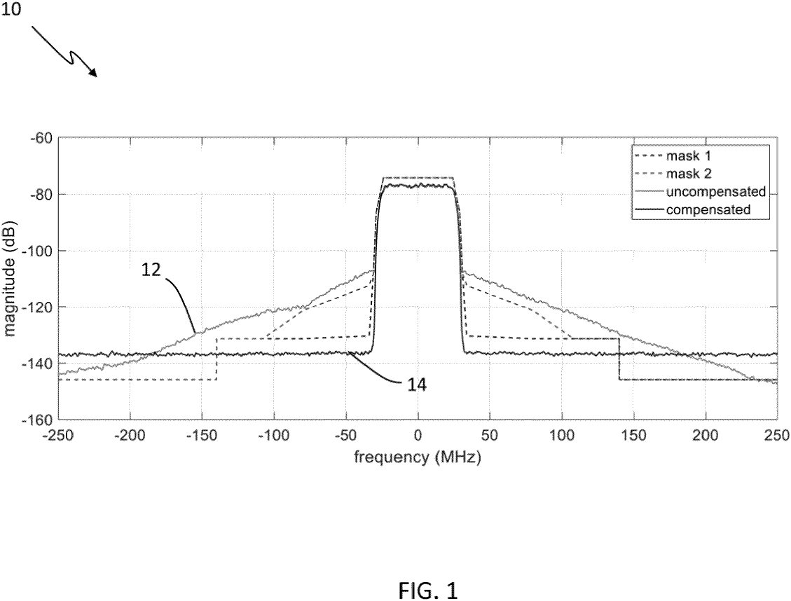

Available spectral spreading headroom is limited by nonlinear distortion, electronic noise, and transmission channel effects, which in turn affects bit error rate (BER), error correction requirements, range capabilities, and receiver sensitivity. For example, FIG. 1 is a graphical illustration 10 of spectral spreading headroom, in accordance with embodiments of the present disclosure, showing the effects of DPD linearization and receiver linearization to increase headroom within a typical 5G base station power amplifier (PA). As shown, the typical, uncompensated, spectral regrowth 12 for this situation is already significant, such that there is no room for a TM sideband modulation. Using DPD techniques, it is possible to generate the headroom 14 which is necessary for TM sideband modulation, e.g., where the compensated headroom 14 is lower than the spectral regrowth 12 along the guard bands of the allowable frequency mask. This allows for additional waveforms to be added within the allowable frequency mask. TM uses orthogonal modulation to limit intersymbol interference (ISI) with the main band signal.

Communications waveform specifications, e.g., constellation density, is limited by SINR, which also affects BER, error correction, range, and sensitivity. SINR headroom is limited by noise, nonlinear distortion, and channel effects. Transmit DPD linearization and receiver nonlinear equalization (NLEQ) can also increase this type of headroom to allow additional waveforms in the allowable SINR specification.

Enhancement of conventional communications systems with the addition of TM signals can be accomplished by modulation of the TM waveforms to align with the natural intermodulation distortion of the conventional or “legacy” waveform. Odd-order nonlinear intermodulation distortion causes spectral spreading into the guard bands of digital communications systems. TM waveforms are designed to mimic the characteristics (including frequency and amplitude) of the intermodulation distortion, since conventional receivers are already provisioned to handle this distortion. In addition, obfuscated communications may be possible with such modulated TM signals since they are indistinguishable from natural nonlineardistortion, and thus, would be recognized as noise or distortion by conventional receivers,whereas TM receivers can detect modulated TM signals.

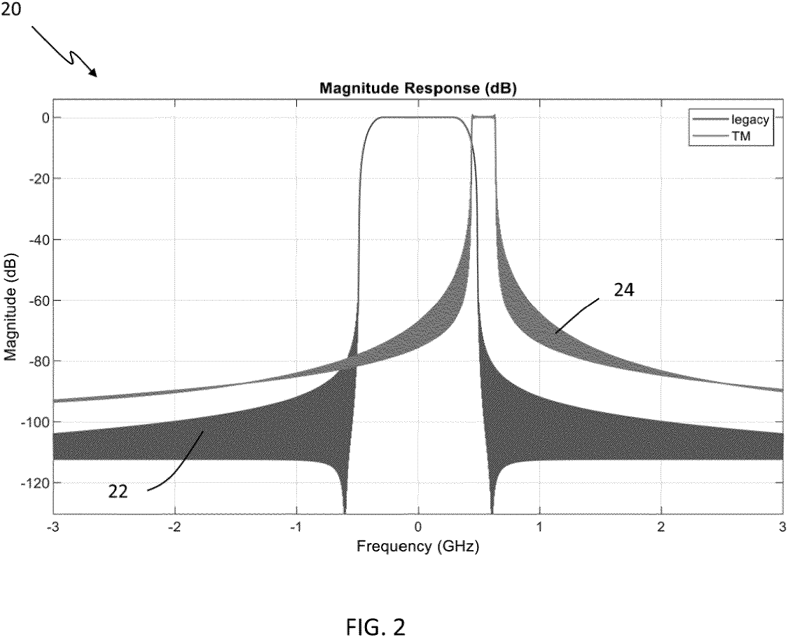

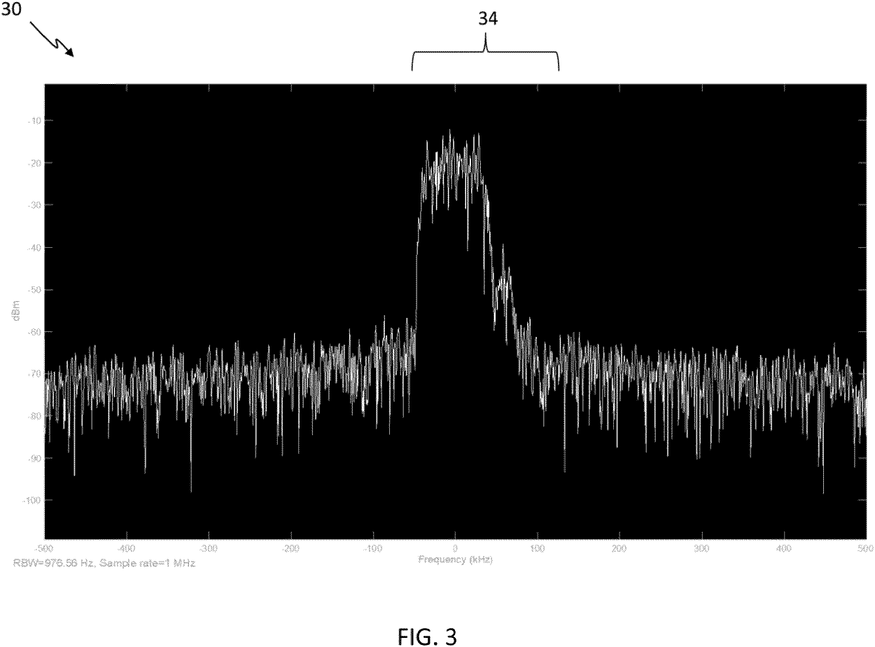

For systems enhanced with the addition of TM waveforms, signal demodulation may first be performed on the original legacy waveform with no modifications, insuring full backward compatibility. Then, demodulation may be performed on each of the TM signals. Orthogonal matched filtering may then be used to extract the TM signal. This can be seen in FIG. 2, which is a graphical illustration 20 of the frequency response of a matched filter used to demodulate a TM signal, in accordance with embodiments of the present disclosure. As shown in FIG. 2, the legacy signal 22 is depicted with a TM signal 24, where the TM signal 24 is demodulated such that it is orthogonal to the matched filter used for the waveform of the legacy signal 22. In this example, only one TM signal 24 is depicted for clarity. The matched filters may then be applied to the total received spectrum, as shown in FIG. 3. FIG. 3 is a graphical illustration 30 of a total received spectrum 34 of a legacy signal 22 and TM signal 24 of FIG. 2, in accordance with embodiments of the present disclosure.

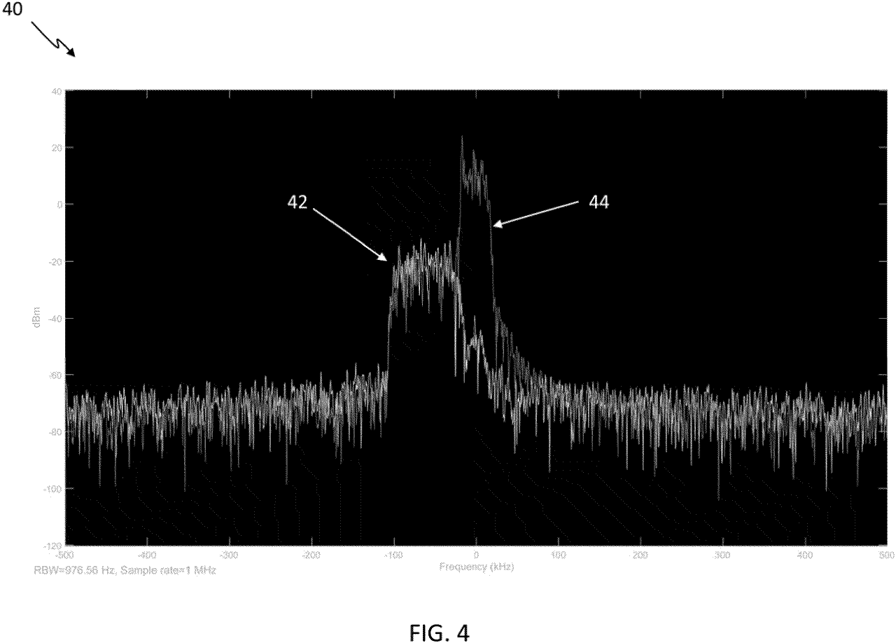

When the orthogonal matched filter is applied, the result may be as depicted in FIG. 4, which is a graphical illustration 40 of a detected and enhanced TM signal after application of the orthogonal matched filter of FIG. 2, in accordance with embodiments of the present disclosure. As shown, the enhanced TM spectrum 44 of the TM signal 24 (FIG. 2) can be seen relative to the spectrum 42 corresponding to the legacy signal 22 (FIG. 2), where the signals have been processed through orthogonal matched filtering. The TM signal may then be extracted from the composite waveform with high SINR. SINR can be further enhanced by cancellation of the original legacy signal, which can be accurately estimated by remodulation of the received signal. The orthogonal matched filter generally provides sufficient SINR to demodulate the TM signal. A further enhancement of the demodulation of the TM signal can be achieved by detecting and demodulating the legacy signal, re-modulating that signal to form a cancellation signal, and then subtracting the cancellation signal. This method can be used, for example, to increase the SINR to allow for lower BER or increased information density in the TM signal.

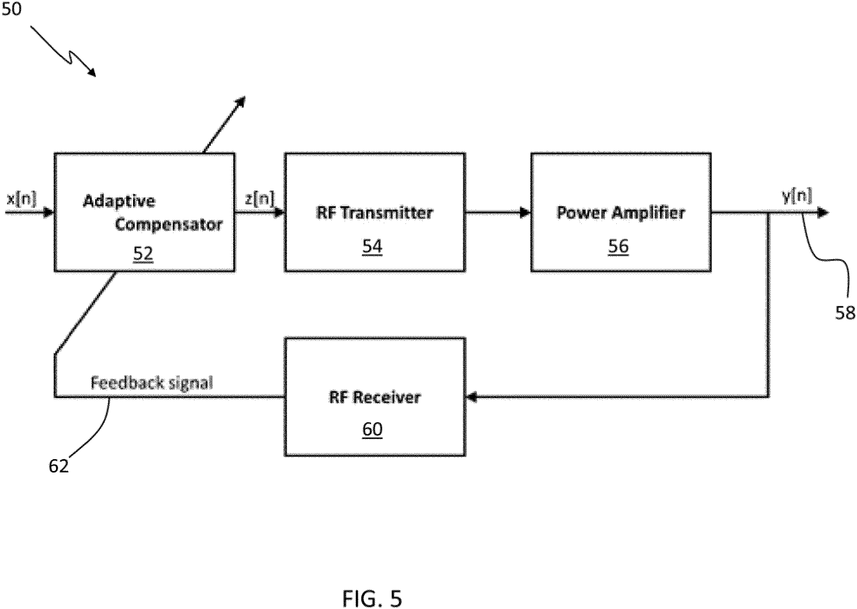

An efficient adaptive digital pre-distortion using a novel multi-dimensional nonlinear model can be used to provide spectral headroom within regulatory mask requirements to allow the addition of one or more TM signals, and as such, DPD linearization provides headroom under regulatory masks for the addition of TM signals. FIG. 5 is a diagrammatical illustration 50 of an adaptive multi-dimensional compensator applied to predistortion of an RF transmitter, in accordance with embodiments of the present disclosure. As shown in FIG. 5, an adaptive, multi-dimensional compensator 52 may effectively mitigate linear and nonlinear distortion in RF power transmitter 54 electronics by modeling the state of the device by tracking multiple functions of the input. These functions can include, for example, the present input signal value, delayed values of the input (for memory effects), derivatives of the input (including higher order derivatives), integration of the input (including higher order integrals), signal statistics (e.g., mean, variance), current power level (RMS or peak), and polynomial functions of the input, among others. The processing may be implemented with memory instead of digital multipliers for low-power applications. It may be calibrated using arithmetic operations that can be completed with low processing requirements and very quickly to track parameters that rapidly change over time, temperature, and power level such as in frequency-hopping systems. It can be implemented in hardware without the use of any digital multipliers and operates at very wide instantaneous bandwidths (e.g., >1 GHz instantaneous bandwidth). In experimentation, this approach has provided a 15-30 dB improvement in distortion.

Fundamentally, the algorithm may generate a pre-distortion signal that negates the distortion on the desired output caused by the underlying nonlinear system. For a stream of digital data, each data sample may be corrupted by distortion effects and may need its own correction value. Additionally for a nonlinear system, the effect is a function of not only the input itself but also higher order statistics, such as derivative and moment. The multi-dimensional compensator described herein may be a multi-dimensional look up table (LUT), where the dimension is indexed by the sample values, or code, and the second dimension is indexed by the derivative, and higher dimensions are indexed by high order statistics. For most applications, it is possible for the nonlinearity to be sufficiently modeled by the code and the derivative, which makes the compensator a 2D LUT.

When there is no distortion, one ideal output of the transmitter is simply a gain of the input signal y[n] = Gx[n]. In practice, the output may be compressed and distorted by the nonlinearity, especially operating in high gain regions, which can generally be modeled as a Volterra series. The pre-distorted system output, y[n], is generated by an M^{th} order Volterra model that is comprised of the summation of M Volterra operations on the input signal, x[n], given by Equation 1:

$$y \left[n\right] = {\sum }_{m = 1}^{M} {y}_{m} \left[n\right] = {\sum }_{m = 1}^{M} \left〈{H}_{m} , x \left[n\right]\right〉$$

where the m^{th} order term is the tensor inner product between the m^{th} order Volterra kernel, hₘ, and the m^{th} order tensor outer product of the input signal, x[n], given by Equation 2:

$$\begin{matrix}\left〈{H}_{m} , x \left[n\right]\right〉 = \\ {\sum }_{{k}_{1} = 1}^{K} {\sum }_{{k}_{2} = 1}^{K} ⋯ {\sum }_{{k}_{M} = 1}^{K} {h}_{m} \left[{k}_{1} , {k}_{2} , ⋯ , {k}_{M}\right] {\prod }_{l = 1}^{M} x \left[n - {k}_{l} - 1\right]\end{matrix}$$

where K represents the memory of the system. The order M may be chosen based on the observed order of nonlinearity in the RF power amplifier being pre-distorted.

Continuing with FIG. 5, the signal from the RF transmitter 54 goes through a Power Amplifier (PA) 56 and may be output as the pre-distorted system output at 58, or it may be received by an RF receiver 60. The RF transmitter 54 and the RF receiver 60 may be Digital-to-Analog Converters (DAC) and Analog-to-Digital Converters (ADC). Although they may also contain nonlinearities themselves, the effect in the overall system is often dominated by that of the RF power amplifier 56. Since the ideal output signal is known, a 2D LUT that aims to negate the overall distortion effect for each code, a derivative pair can be iteratively calibrated based on a feedback signal 62.

To train the table, the total error signal, e[n], between the output, y[n], and the ideal output, Gx[n], may first need to be computed. Alignment of the input signal and the output may be necessary because there is a system delay that may be frequency dependent. Because of the memory effects in the system, a general gradient descent algorithm may be applied to ensure that the error values converge by monitoring the output, y[n], until it converges to Gx[n] while iteratively updating the input, x[n].

Mathematically, the pre-distortion technique may effectively correct any undesired effect throughout the system. System implementations, however, may require a compensator that can quickly converge and whose complexity can be managed systematically. The multi-dimensional compensator 52 may be a 2^{Nbits} × M 2D LUT (where Nbits is the number of quantization bits of each digital sample, and M is the number of quantized slope values). The LUT entries may be calculated as the averaged error value, e[n], for a given code/slope pair, as shown in FIG. 2.

The LUT may be indexed by the present value and the instantaneous derivative. The present value may be the digital input level of the current signal. The second index may be obtained by calculating the derivative of the signal, and in one implementation, this can be achieved through an FIR filter with frequency response that approximates the derivative function. A much less complex and still effective method for estimating the first derivative, however, may be the first difference, which requires no multipliers.

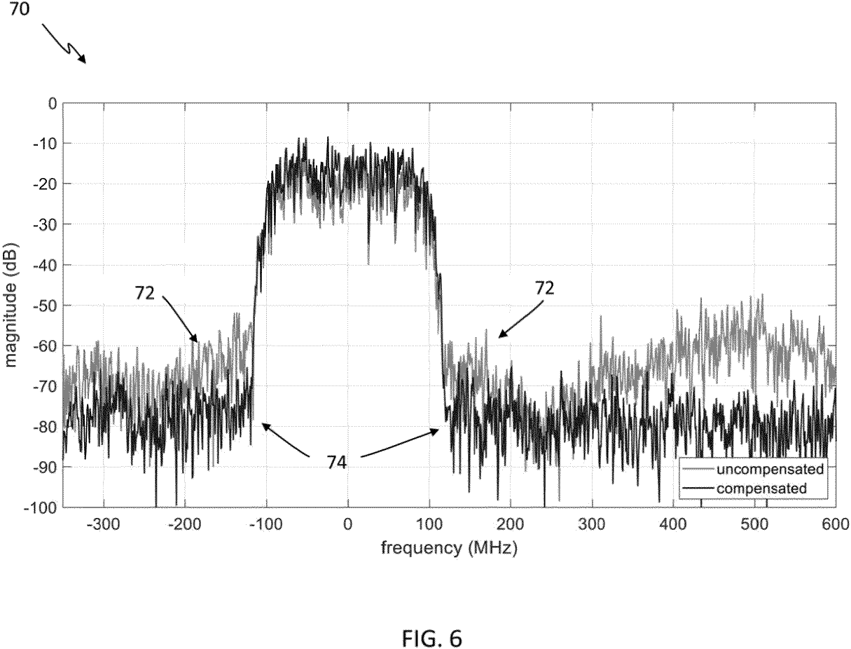

In one example, a commercial off-the-shelf 50 W GaN RF power amplifier with 1 GHz instantaneous bandwidth may be used to demonstrate the performance of the algorithm. The power amplifier has a nonlinear compression profile, before and after compensation. The algorithm may be configured with 12 bits and M=64 slopes, and it may use the first difference approximation for the derivative calculation. The multi-dimensional compensator may provide 15-30 dB improvement in nonlinear distortion such as intermodulation distortion, and in turn, it can be used to provide room within a regulatory emissions mask to add TM signals. This can be seen in FIG. 6, which is a graphical illustration showing the effect of DPD linearization on a modulated waveform, in accordance with embodiments of the present disclosure. As shown, when linearization digital signal processing is applied to the test system, there is a reduction in spectral spreading, shown at 72, to provide room within a regulatory spectral emissions mask to add multiple TM signals. The signal after linearization is shown at 74.

Experimentation has been conducted to test hardware components, including a waveform configuration using a WLAN (OFDM) transmit and receive framework, 64QAM 20 MHz + 16QAM 5 MHz TM bands, and TM signal levels set to fit under 802.11a mask. Analog Devices AD9361 RF Agile Transceiver was used as a software-defined radio, an RF transmit power amplifier comprised an Aethercomm SSP 0.02-6.00-35 5G Basestation Amplifier (6 GHz), and a Xilinx Zynq UltraScale+ MPSoC ZCU102 FPGA Board was used as a digital signal processing interface. The test configuration uses an interface to MATLAB to verify the addition and successful demodulation of four separate TM signals on the legacy WLAN receiver system with minimal impact on the demodulation of the legacy signal.

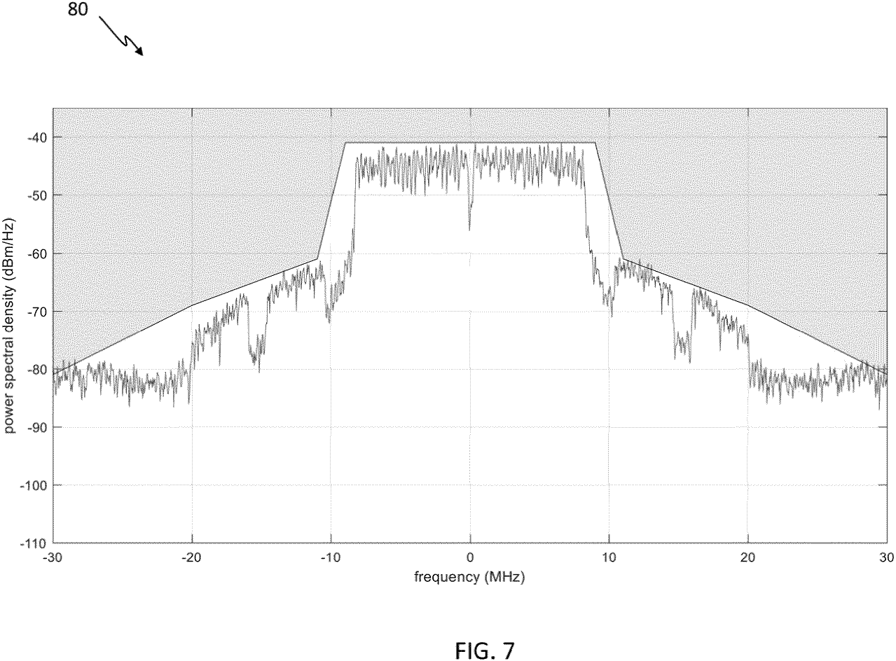

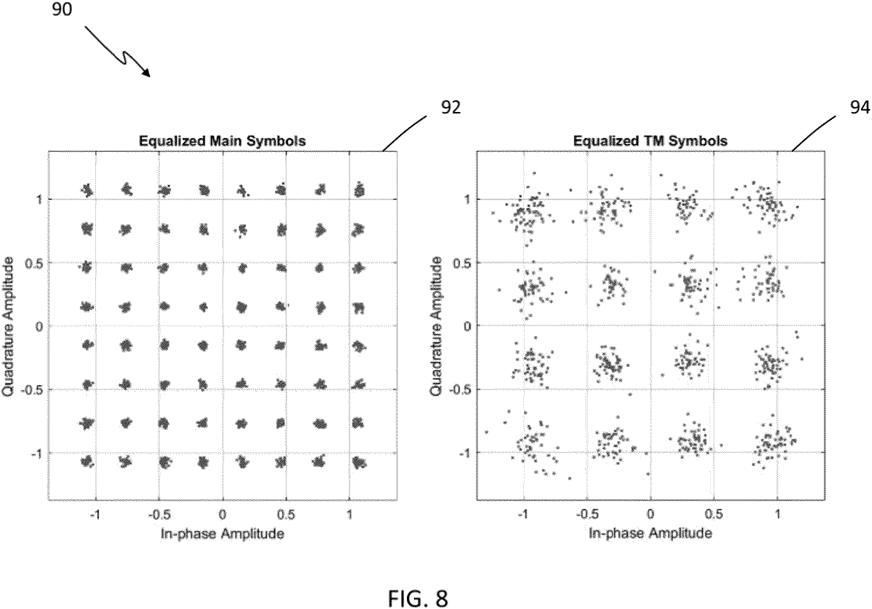

The experiment showed the received spectrum with the addition of four simultaneous TM signals (16QAM) along with the legacy 64QAM WLAN signal using the hardware test setup, as shown in FIG. 7, which is a graphical illustration 80 showing experimentation results showing the spectrum with TM signals, in accordance with embodiments of the present disclosure. As shown, a total of four simultaneous TM signals were added (centered at -17.5 MHz, -12.5 MHz, +12.5 MHz, and +17.5 MHz) in addition to the main signal centered at 0 MHz (all baseband frequencies). None of the signals exceeds the FCC mask. It is noted that there is still additional room under the mask to support the addition of several more TM signals, if desired. The experimentation also proved that there is no degradation of signal. For example, FIG. 8 is a graphical illustration 90 constellation plot for the original legacy signal 92 and one of the TM signals 94 of the experimentation of FIG. 7, in accordance with embodiments of the present disclosure. As shown, the received constellation plot for the original WLAN signal confirms no degradation, as well as the successful demodulation of one of the 16QAM TM signals. Allowing for overhead for coding and error correction, the additional four TM signals increased the data throughput of the original WLAN signal by 47.8%. This demonstrates that the original signal is unaffected, and the added TM signal are successfully demodulated.

Using the TM techniques described relative to FIGS. 1-8, the subject disclosure is directed to systems and methods of TM fortified communication which can be used to increase the effective or usable bandwidth in a spectral mask, provide obfuscation of signal data, and other benefits to wireless communications.

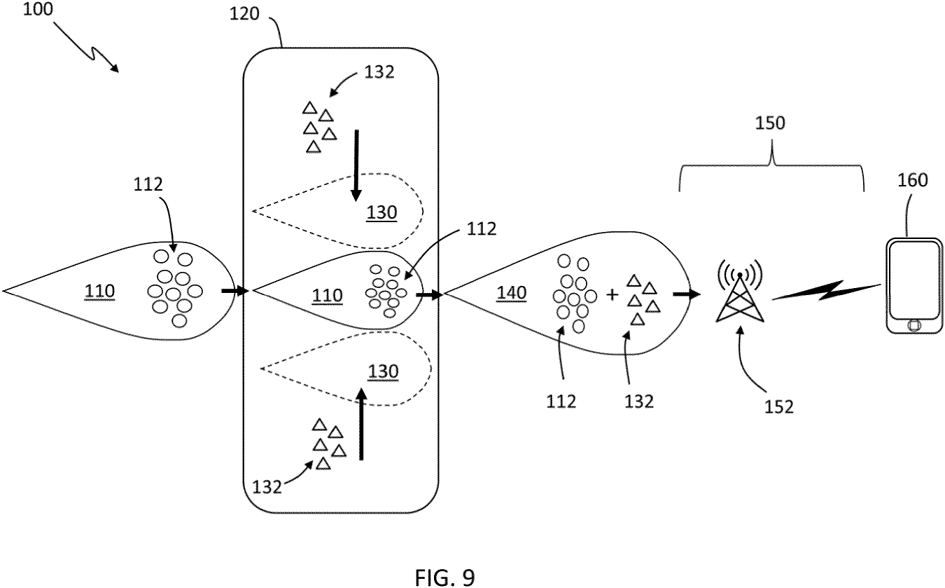

FIG. 9 is a diagrammatical illustration of a system for transpositional modulation fortified communication 100, in accordance with embodiments of the present disclosure. The system for transpositional modulation fortified communication 100, which may be referred to herein simply as ‘system 100’ includes an original carrier 110 of an RF channel operating within a spectral mask 120. The original carrier 110 of the RF wireless channel has a carrier signal with a first quantity of data 112. The first quantity of data 112 may include any type of data, for instance, textual, visual, pictographic, videographic, encrypted, or other types of data which may be transmitted between electronic devices, such as computers, servers, cellular phones, or other computing devices. The original carrier 110 may move through a network system through various devices, processes, or iterations. For example, in digital communication, the information source may be transmitted on a channel, where various encoders, digital modulators, digital demodulators, receivers, channel decoders and receivers, and/or source decoders and receivers are used to process and transmit the signal.

The original carrier 110 operates within the spectral mask 120, within the spectrum, e.g., parameter or boundary of levels, of RF transmission for a particular communication protocol which is often defined by an organization such as the FCC, the ITU, or the ETSI, or another organization. The spectral mask 120 may be defined by different frequencies for various types of signals or communication protocols. For example, 4G communication networks commonly operate within 700 MHz-2500 MHz while 5G ultra-wideband may operate at frequencies of approximately 28 GHz and 39 GHz.

While the original carrier 110 is moving through the transmission process, at least one transpositional modulation (TM) channel 130 is added to the original carrier 110, thereby generating a TM fortified carrier 140 with signal. As shown in FIG. 9, the TM channel 130, or TM mods, includes a second quantity of data 132. When the TM channel 130 is added to the original carrier 110 to form the TM fortified carrier 140, the first quantity of data 112 of the original carrier 110 and the second quantity of data 132 of the TM channel 130 are both included in the TM fortified carrier 140. The first and second quantities of data 112, 132 may remain separate within the TM fortified carrier 140, or be combined in whole or part. When the at least one TM channel 130 and the original carrier 110 are formed into the TM fortified carrier 140, the combined signal and data remains under the spectral mask 120, such that the collective signals and data do not exceed the spectral mask 120.

It is noted that any number of TM channels 130 may be added to the original carrier 110, so long as the cumulative signal of the added TM channels 130 with the original carrier 110 remains within the spectral mask 120. For instance, as discussed relative to FIG. 2, the TM signal may be demodulated to be orthogonal to a matched filter used for a waveform of the signal of the original carrier 110, where FIG. 2 illustrates a single TM signal for clarity in disclosure. In FIG. 9, however, two TM channels 130 are depicted being added to the original carrier 110. It is possible to only include one TM channel, or to include a plurality of TM channels 130, as may be dependent on the system and its intended use. The TM channel or channels 130 added may utilize sidebands or lobes within the original waveform of the spectral mask 120, such that they remain within the spectral mask 120. This allows the sidebands of the original waveform to be used for communication purposes beyond that traditionally used with the original carrier 110, which increases the usable bandwidth within the spectral mask 120. As such, it is possible to transmit a larger quantity of data within the spectral mask 120 using the TM channels 130 in comparison to conventional techniques using only an original carrier 110 or using non-TM modulation.

The fortified TM carrier 140 may then be sent through the network 150 to an end destination. For instance, the network 150 may include various antennas 152 which are used to transmit fortified TM carrier 140 signals. Other network devices may also be used. One or more electronic or computerized devices 160, such as computers, smart phones, or similar electronics may be connected to the network 150 and receive the fortified TM carrier 140, where all or part of the data within the fortified TM carrier 140 can be decoded and received. One benefit of the system 100 is the superior quality of experience that the user of the electronic device 160 achieves, in data transmission speed, increased bandwidth, and increased security and/or privacy.

With regards to increased data transmission speed and bandwidth, the utilization of the TM channel 130 on the sidebands of the spectral mask 120 allows for the ability to include a larger quantity of data than using only the original carrier 110, since additional data can be transmitted within the TM channels 130 without detracting from the bandwidth of the original carrier 110. This effectively increases the overall bandwidth that is usable within the spectrum. In turn, this can be used to transmit more data at a given time than has been conventionally used within a given spectral mask 120, thereby providing increased transmission speeds. In mobile networks, such as with 5G bandwidths using less spectrum, the system 100 can provide a multifold increase in bandwidth out of an existing mobile network operator’s spectrum. For instance, in some situations, the system 100 can effectively double the bandwidth in an existing network.

While a conventional receiver of the electronic device 160 may be capable of receiving the first quantity of data 112 of the original carrier 110, it is not capable of receiving the second quantity of data 132 of the TM channel 130. This is because conventional (non-TM) receivers are not capable of deciphering the data within the TM channel 130, since these conventional receivers identify this data as noise, and thus ignore this data. Accordingly, it is possible to utilize this characteristic of conventional receivers to effectively secure or obfuscate the second quantity of data 132 within the TM channel 130 from devices 160 which only utilize conventional, non-TM receivers.

However, when the device 160 includes a TM-receiver, e.g., a receiver capable of receiving and identifying data transmitted within a TM channel 130, it is possible for the device 160 to successfully recognize the second quantity of data 132 within the TM channel 130 and thus receive it. In other words, a TM-receiver is capable of identifying that the second quantity of data 132 which is transmitted within the TM channel 130 is not noise, where the TM-receiver decodes the second quantity of data 132 instead of ignoring it. In this way, it is possible to use the TM channel 130 for the transmission of data which requires heightened security, privacy, or otherwise is desired to be kept from being received by a device 160 with only a conventional receiver. For example, it may be possible to send null signals within the first quantity of data 112 of the original carrier 110, while important or sensitive data is sent within the second quantity of data 132 of the TM channel 130.

This technique can be used to provide secure communications which meets or exceeds the security required by various industries or organizations, such as, for example, the strict privacy requirements of electronic healthcare records, security requirements of the financial industry, or security requirements of the Department of Defense (DOD). For the DOD specifically, the system 100 can achieve covert level security such as zero trust architecture (ZTA), where secure communication is achieved using TM on detection (TMOD), which enables DOD level security to mobile networks.

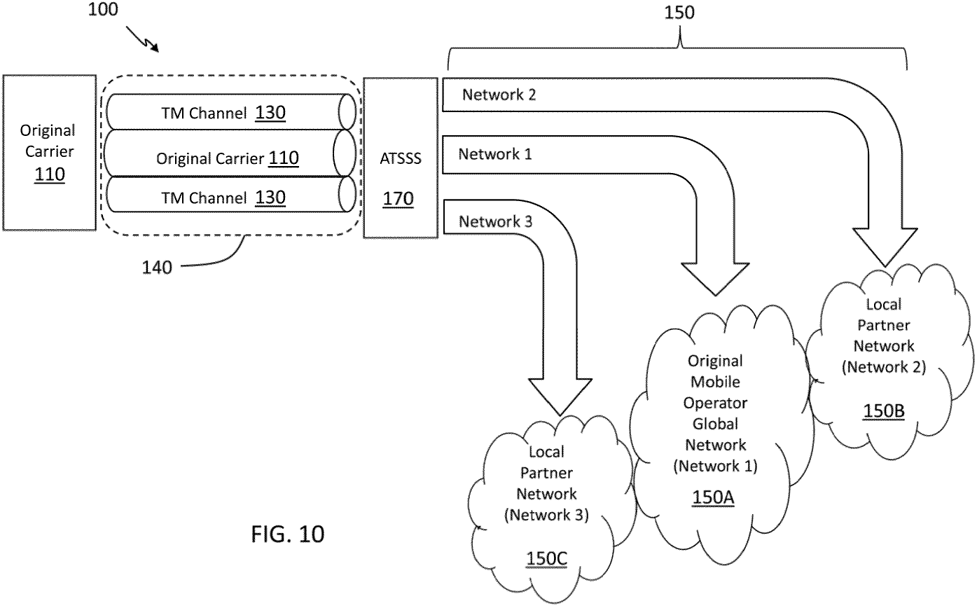

The system 100 can also be used to provide network splitting with TM fortified communication. FIG. 10 is a diagrammatical illustration of the system for transpositional modulation fortified communication 100 with network splitting, in accordance with embodiments of the present disclosure. Referring to FIG. 10, the original carrier 110 is provided with one or more TM channels 130 to form the TM fortified carrier 140, as previously described in FIG. 9. The TM fortified carrier 140 may be processed through an access traffic, steering, switching, and splitting (ATSSS) unit 170 which operates as a rules engine to modify, direct, or otherwise alter the signal or signals of the TM fortified carrier 140. In particular, the ATSSS unit 170 may direct the TM fortified carrier 140 through the network 150 and to a user device 160 (FIG. 9). The 3rd Generation Partnership Project (3GPP) release 16 (Rel 16) has introduced ATSSS which allows user traffic steering across multiple access technologies such as 5G, 4G, WiFi, Wireless, Satellite etc., at a finer granularities than a PDU session. ATSSS introduces multi-access PDU session, a PDU session for which the data traffic can be served over one or more concurrent accesses such as trusted 3GPP and non-3GPP access, and untrusted non-3GPP access.

The ATSSS unit 170 can be characterized as a device or module which is capable of steering a wireless signal, such as by steering the signal between 5G and WiFi paths to achieve the best network selection. The ATSSS unit 170 can also switch the signal between 5G and WiFi, thereby providing seamless handover of the signal. It is also possible for the ATSSS unit 170 to split the signal between communication protocols, such as between 5G and WiFi to achieve network aggregation. In these examples, the ATSSS unit 170 is described relative to 5G and WiFi, but it is noted that the ATSSS unit 170 can also be used with other communication protocols not explicitly referenced herein. While ATSSS systems are typically used to steer, switch, or split a signal to achieve an improved wireless signal transmission, the ATSSS unit 170 may be used to advantageously split the signal of the TM fortified carrier 140 into different data paths within a single communication protocol of the network 150 itself. Also, ATSSS systems typically steer, split, or switch between 5G and WiFi, but the system 100 can utilize TM, as previously described, to utilize 5G networks without the need for steering, splitting, or switching to WiFi.

In the system 100, the network 150 may be separated into a plurality of subnetworks, such as a first network 150A, a second network 150B, and a third network 150C, which are representative of three data paths. It is noted that any number of subnetworks may be included within the system 100, including fewer or greater than the three subnetworks depicted in FIG. 10, so long as all subnetworks are within the spectrum. Each of the subnetworks 150A-150C may operate as a data path through which data within the TM fortified carrier 140 can be transmitted. Each of the subnetworks 150A-150C may be within the same communication medium, e.g., all within 5G or WiFi, with the ability to choose which medium to use, versus traditional ATSSS splitting between 5G and WiFi, where both mediums are used. It is also noted that 3GPP provides for network splitting within the main waveform, but this requires additional network IDs and effectively remains a single network within the original carrier. The system 100, in contrast, can add additional networks through the use of TM, which increases the usable space within the spectrum, such that additional networks with optionally different parameters can be utilized. It is further noted that each of the subnetworks 150A-150C may be separated into further subnetworks. For instance, each of the subnetworks 150A-150C may become three 5G networks, when traditional ATSSS is overlaid on the system 100.

The system 100 may utilize the subnetworks 150A-150C to transmit different parts of the TM fortified carrier 140 signal in different subnetworks 150A-150C, thereby allowing for selective control of the network path for a particular type of signal data. For instance, with multiple data paths, wherein the first and second quantities of data 112, 132 (FIG. 9) are transmittable along different paths from one another, such that the original carrier signal data can be transmitted along a different subnetwork from that of the data within the TM channel 130 (FIG. 9).

It can be beneficial for the subnetworks 150A-150B to have different parameters which are configured to provide different data transmission benefits. For instance, network 1 150A can offer faster data transmission speeds, while network 2 150B can offer different privacy protocols, while network 3 150C can provide different security protocols. A user or wireless operator can then use these different parameters of the subnetworks 150A-150C to provide adjustable or tailored use based on a desired type of enhancement. For example, a user who desires faster transmission speeds but does not need increased security or privacy can be directed to network 1 150A, while a user who desired heightened privacy can be directed to network 3 150C. The subnetworks 150A-150C can effectively be used to provide dynamic wireless communications to users based on the user’s own preference.

As an example, a global network, such as AT&T® or Verizon®, can utilize this network splitting by providing one main network (network 1) for standard wireless communication, but then offer certain customers improved data transmission through other subnetworks (network 2 or network 3). For instance, network 2 or network 3 could be used for local networks, while network 1 is a global network, or network 2 and network 3 could be used for secure communications utilized by commercial or governmental customers where enhanced security is provided, such as through the aforementioned obfuscation techniques. This system 100 can be used to generate increased revenue for network operators by providing enhanced data transmission networks to customers willing to pay more for these services. These so-called ‘local edge’ communications can be avenues for new revenue generation by enabling localized data communications on the mobile edge of the spectrum.

TM enables 5G Rel 16 ATSSS features without sacrificing original waveform bandwidth by adding additional waveforms to the bandwidth. This creates multiple subnetworks in addition to, for example, a main operator global PLMN network. Additional subnetworks can be used to create localized small networks, and hence, introduce integrated global-local networks by using 3GPP ATSSS features.

In one example, the multiple data paths provide full duplex operation on a single frequency carrier, which is achieved by TM emulating multiple data paths on a single carrier, thereby providing full duplex on a frequency, which may be usable in future communication standards, such as within 3GPP Rel 18 SFFD 5G advanced & 6G.

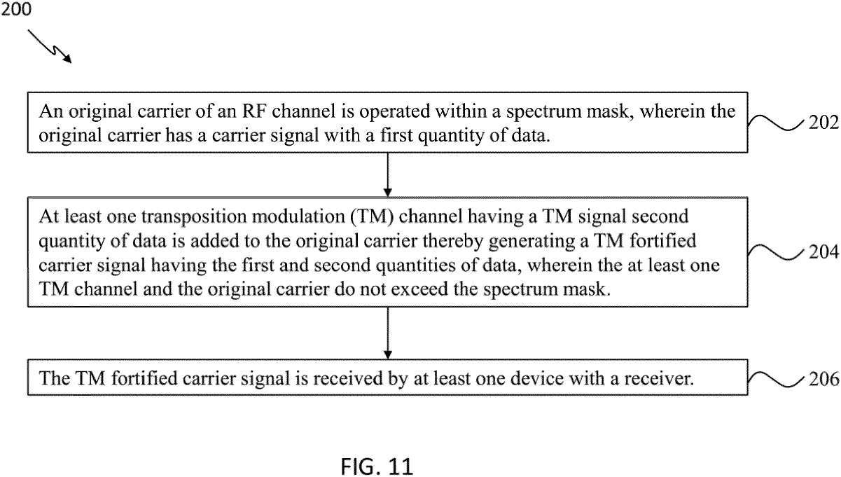

FIG. 11 is a flowchart illustrating a method of transpositional modulation fortified communication, in accordance with embodiments of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, an original carrier of an RF channel is operated within a spectral mask, wherein the original carrier has a carrier signal with a first quantity of data. At least one transpositional modulation (TM) channel having a TM signal second quantity of data is added to the original carrier thereby generating a TM fortified carrier signal having the first and second quantities of data, wherein the at least one TM channel and the original carrier do not exceed the spectral mask (block 204). The TM fortified carrier signal is received by at least one device with a receiver (block 206).

Any number of additional steps, functions, processes, or variants thereof may be included in the method, including any disclosed relative to any other figure of this disclosure. For instance, the at least one TM channel utilizes sidebands within the spectral mask. The spectral mask may be defined by at least one of the FCC, the ITU, or the ETSI. The receiver may further comprise a non-TM receiver, wherein the non-TM receiver receives the first quantity of data but ignores the second quantity of data, thereby obfuscating the second quantity of data from the at least one device. The receiver may further comprise a TM receiver, wherein the TM receiver receives the first and second quantities of data. The TM signal may be demodulated to be orthogonal to a matched filter used for a waveform of carrier signal. The TM fortified carrier signal may further comprise multiple data paths, wherein the first and second quantities of data are transmittable along different paths of the multiple data paths. The multiple data paths may provide full duplex operation on a single frequency carrier.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A system for transpositional modulation fortified communication comprising:
an original carrier of an RF channel operating within a spectral mask, the original carrier having a carrier signal with a first quantity of data;
at least one transpositional modulation (TM) channel having a TM signal second quantity of data, wherein the at least one TM channel is added to the original carrier thereby generating a TM fortified carrier signal having the first and second quantities of data, wherein the at least one TM channel and the original carrier do not exceed the spectral mask; and
at least one device with a receiver receiving the TM fortified carrier signal.

2. The system of claim 1, wherein the at least one TM channel utilizes sidebands within the spectral mask.

3. The system of claim 1, wherein the spectral mask is defined by at least one of the FCC, the ITU, or the ETSI.

4. The system of claim 1, wherein the receiver further comprises a non-TM receiver, wherein the non-TM receiver receives the first quantity of data but ignores the second quantity of data.

5. The system of claim 4, wherein the second quantity of data is obfuscated from the at least one device.

6. The system of claim 1, wherein the receiver further comprises a TM receiver, wherein the TM receiver receives the first and second quantities of data.

7. The system of claim 1, wherein the TM signal is demodulated to be orthogonal to a matched filter used for a waveform of carrier signal.

8. The system of claim 1, wherein at least one digital pre-distortion (DPD) linearization technique is used to increase headroom for the TM fortified carrier signal within the spectral mask.

9. The system of claim 8, wherein the increased headroom is lower than spectral regrowth along guard bands of the spectral mask.

10. The system of claim 1, wherein the TM fortified carrier signal further comprises multiple data paths, wherein the first and second quantities of data are transmittable along different paths of the multiple data paths.

11. The system of claim 10, wherein the multiple data paths provide full duplex operation on a single frequency carrier.

12. A method for transpositional modulation fortified communication, the method comprising:
operating an original carrier of an RF channel within a spectral mask, wherein the original carrier has a carrier signal with a first quantity of data;
adding at least one transpositional modulation (TM) channel having a TM signal second quantity of data to the original carrier thereby generating a TM fortified carrier signal having the first and second quantities of data, wherein the at least one TM channel and the original carrier do not exceed the spectral mask; and
receiving the TM fortified carrier signal on at least one device with a receiver.

13. The method of claim 12, wherein the at least one TM channel utilizes sidebands within the spectral mask.

14. The method of claim 12, wherein the spectral mask is defined by at least one of the FCC, the ITU, or the ETSI.

15. The method of claim 12, wherein the receiver further comprises a non-TM receiver, wherein the non-TM receiver receives the first quantity of data but ignores the second quantity of data, thereby obfuscating the second quantity of data from the at least one device.

16. The method of claim 12, wherein the receiver further comprises a TM receiver, wherein the TM receiver receives the first and second quantities of data.

17. The method of claim 12, wherein the TM signal is demodulated to be orthogonal to a matched filter used for a waveform of carrier signal.

18. The method of claim 12, wherein the TM fortified carrier signal further comprises multiple data paths, wherein the first and second quantities of data are transmittable along different paths of the multiple data paths.

19. The method of claim 18, wherein the multiple data paths provide full duplex operation on a single frequency carrier.

20. A system for highly secured signal communication using transpositional modulation comprising:
an original carrier of an RF channel operating within a spectral mask, the original carrier having a carrier signal with a first quantity of data;
at least one transpositional modulation (TM) channel having a TM signal second quantity of data, wherein the at least one TM channel is added to the original carrier thereby generating a TM fortified carrier signal having the first and second quantities of data, wherein the at least one TM channel and the original carrier do not exceed the spectral mask;
an access traffic steering, switching, and splitting (ATSSS) unit directing the TM fortified carrier signal through at least first and second networks, wherein at least a portion of the first quantity of data is transmitted through the first network and at least a portion of the second quantity of data is transmitted through the second network,
wherein the first and second networks have at least one of: different network speeds; different privacy protocols; or different security protocols; and
at least one device with a receiver receiving at least one of the first and second quantities of data within the TM fortified carrier signal.

21. The system of claim 20 wherein the receiver of the at least one device further comprises a non-TM receiver, wherein the non-TM receiver receives the first quantity of data but ignores the second quantity of data, wherein the second quantity of data is obfuscated from the at least one device.

22. The system of claim 20, wherein the receiver of the at least one device further comprises a TM receiver, wherein the TM receiver receives the first and second quantities of data.
